(19) United States
(12) Patent Application Publication
(10) Pub. No.: US 2019/0090305 A1
(43) Pub. Date: Mar. 21, 2019

(54) SYSTEM AND METHOD FOR PROVIDING SECURE AND REDUNDANT COMMUNICATIONS AND PROCESSING FOR A COLLECTION OF MULTI-STATE INTERNET OF THINGS (IoT) DEVICES

(71) Applicant: Unisys Corporation, Blue Bell, PA (US)

(72) Inventors: James R. Hunter, Malvern, PA (US); Craig R. Church, Malvern, PA (US); Nandish Jayaram Kopri, Malvern, PA (US)

(21) Appl. No.: 15/709,910

(22) Filed: Sep. 20, 2017

(51) Int. Cl. H04W 84/04; H04W 72/04; H04L 12/66

(52) U.S. Cl. CPC H04W 84/04; H04L 12/66; H04W 72/04

(57) ABSTRACT

This application relates in general to a method, apparatus, and article of manufacture for providing secure and redundant communications and processing for a collection of Internet of Things having multi-state and programmable IoT devices. These multi-state edge devices typically operate in a default state with a default network configuration. When a scheduled or external event is detected by a IoT host server, this server reconfigures the operating state of the multi-state edge devices and supporting network components to support the needs corresponding to the detected event.

### RELATED APPLICATIONS

This application related to the following commonly assigned U.S. Patents and U.S. Patent Applications:
a. Hunter, et al., entitled SYSTEM AND METHOD FOR PROVIDING SECURE AND REDUNDANT COMMUNICATIONS AND PROCESSING FOR A COLLECTION OF MULTI-STATE INTERNET OF THINGS (IOT) DEVICES, attorney docket no. TN649A, Ser. No. 15/613,612, filed Jun. 5, 2017, currently pending; and
b. Hunter, et al., entitled SYSTEM AND METHOD FOR PROVIDING SECURE AND REDUNDANT COMMUNICATIONS AND PROCESSING FOR A COLLECTION OF MULTI-STATE INTERNET OF THINGS (IOT) DEVICES, attorney docket no. TN649B, Ser. No. 15/613,624, tiled Jun. 5, 2017, currently pending.

The above applications are incorporated by reference in their entirety as if they were recited herein.

### TECHNICAL FIELD

This application relates in general to a method, apparatus, and article of manufacture for providing secure and redundant communications and processing for a collection of multi-state and programmable Internet of Things (IoT) devices connected to a computer network and under control of an IoT Host Server.

### BACKGROUND

For anyone who relies on an IoT network for their 24/7 business needs, “100% uptime” of enough of its components to prevent a usage outage is critical. Given that “100% uptime” has been a longtime goal/characteristic of Unisys and the products it delivers (e.g. Clearpath Forward HA), this segment of the IoT market might align well with our core strengths and with our enterprise customer needs in various verticals we are already in.

There are many “large client” market segments which quickly come to mind, where this could be needed, e.g. “large client,” e.g. transportation, financial, manufacturing companies, which will very likely depend on IoT networks around the clock every day of the year. But even smaller companies using IoT for various purposes might have a need for “100% uptime” for certain aspects of their business, e.g. an IoT network to provide building perimeter/access security via surveillance devices, access devices, etc. In an earlier application, systems and methods are disclosed to provide secure and redundant communications. In these systems, a network is configured and operated to automatically reconfigure its communications links to provide automatic failover ensuring uptime of the IoT device functionality. A need exists to allow for dynamic reconfiguration of network links in response to scheduled events and in response to other external events. Additionally, a need exists to also include programmable, multi-state IoT devices that utilize this communications network to provide additional functionality to the network of IoT devices. A multi-state and programmable IoT device operates in a default mode and can also be programmed to operate is one or more alternate operating modes.

The benefit of the present invention is that it may permit an IoT network of programmable, multi-state IoT devices while operating with improved uptime with automated failover for some of the critical components of the network without requiring the cost of acquisition and installation of a fully redundant set of components. By allowing for dynamic reconfiguration of network links in response to scheduled events and in response to other external events along with specification of how device failures will be reconfigured in a controlled manner, the entire IoT network may remain operational within the possible performance of the remaining devices while providing additional functionality to the network of IoT devices.

The present invention attempts to address the existing limitations in current IoT network and device monitoring according to the principles and example embodiments disclosed herein.

### SUMMARY

In accordance with the present invention, the above and other problems are solved by providing a network of IoT edge devices that operate in a plurality of states and the devices and the supporting network elements are dynamically configured to provide needed functionality in response to detected events.

The great utility of the invention is that a Client can rely on programmable, multi-state IoT device functionality provided by the IoT network around the clock and around the year without concern of an outage that could cause a portion of the business to come to a standstill or could result in a breach of security, safety, or any other absolutely essential usage.

In one embodiment, the present invention corresponds to a method for configuring a plurality of multi-state network devices within a dynamically configurable multi-path communications network within a IoT host server. The method determines a default state for each of the plurality of multi-state devices within the dynamically configurable multi-path communications network, determines a set of node configuration data for each of the plurality of multi-state devices within the dynamically configurable multi-path communications network corresponding to the default state, determines a recommended network topography and gateway functionality using a set of defining parameters; determines a set of gateway configuration data for a set of gateway devices corresponding to the recommended network and gateway functionality, transmits the set of node configuration data for each of the plurality of multi-state devices within the dynamically configurable multi-path communications network and the set of gateway configuration data for a set of gateway devices corresponding to the recommended network and gateway functionality from the IoT host server and starts the operation of each of the plurality of multi-state devices within the dynamically configurable multi-path communications network and the set of gateway devices.

In another embodiment, the present invention corresponds to a computer program product for causing a programmable computing system to implement a method for configuring a plurality of multi-state network devices within a dynamically configurable multi-path communications network within a IoT host server. The method determines a default state for each of the plurality of multi-state devices within the dynamically configurable multi-path communications network, determines a set of node configuration data for each of the plurality of multi-state devices within the dynamically configurable multi-path communications network corresponding to the default state, determines a recommended network topography and gateway functionality using a set of defining parameters; determines a set of gateway configuration data for a set of gateway devices corresponding to the recommended network and gateway functionality, transmits the set of node configuration data for each of the plurality of multi-state devices within the dynamically configurable multi-path communications network and the set of gateway configuration data for a set of gateway devices corresponding to the recommended network and gateway functionality from the IoT host server and starts the operation of each of the plurality of multi-state devices within the dynamically configurable multi-path communications network and the set of gateway devices.

In yet another embodiment, the present invention corresponds to a distributed computing system having an IoT Host server, one or more Gateway devices, and a plurality of IoT Edge devices, for configuring a set of network devices. The IoT Host computer includes an IoT Device Discovery module for discovering all devices within an IoT network, the IoT network comprising an IoT Host computer, one or more gateway devices, and a plurality of IoT Edge devices; a Gateway Config module for recommending a network topography and node functionality using a set of defining parameters; an operator interface module for accepting modifications to one or more of the defining parameters within the set of defining parameters; a Network Present module for updating the network topography and node functionality using the modifications to the defining parameters; and an edge device config module for determining an operating state for each of the plurality of multi-state edge devices within the dynamically configurable multi-path communications network. The operating state for each of the plurality of multi-state edge devices includes a default state and an updated state for each detected event; and each detected event includes a scheduled event and an external event

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other strictures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1a represents one potential embodiment of a IoT network connecting a plurality of multi-state IoT devices providing smart cities functionality;

FIG. 1b represents another potential embodiment of a IoT network connecting a plurality of multi-state IoT devices providing smart cities functionality;

FIG. 1c represents one potential embodiment of a IoT network connecting a plurality of IoT devices to an IoT Host Server via a communications network passing data thru multiple gateway devices according to one embodiment of the present invention;

FIG. 1d illustrates an example embodiment of multi-state IoT devices providing smart cities functionality;

FIG. 2 illustrates a general-purpose computing system for use in implementing as one or more computing embodiments of the present invention;

FIG. 3 illustrates an example IoT Host Server and one Gateway device according to another embodiment of the present invention;

FIG. 4 illustrates an example Remote Gateway device and plurality of IoT devices in the IoT network according to yet another embodiment of the present invention;

FIG. 5 illustrates an example operator interface module within the IoT Host server according to an embodiment of the present invention;

FIG. 6 illustrates an IoT Edge Device Discovery module within the IoT Host server according to another embodiment of the present invention;

FIG. 7 illustrates a System Monitor/Failover module within the IoT Host server according to an embodiment of the present invention;

FIG. 8a illustrates a Gateway Config module within the IoT Host server according to an example embodiment of the present invention;

FIG. 8b illustrates a Gateway Config module within the IoT Host server an example embodiment of the present invention;

FIG. 9 illustrates a flowchart of possible operations that may be performed according to an embodiment of the present invention; and

FIG. 10 illustrates another flowchart of possible operations that may be performed according to an embodiment of the present invention.

### DETAILED DESCRIPTION

This application relates in general to a method, apparatus, and article of manufacture for providing secure and redundant communications and processing for a collection of multi-state and programmable Internet of Things (IoT) devices.

Various embodiments of the present invention will he described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

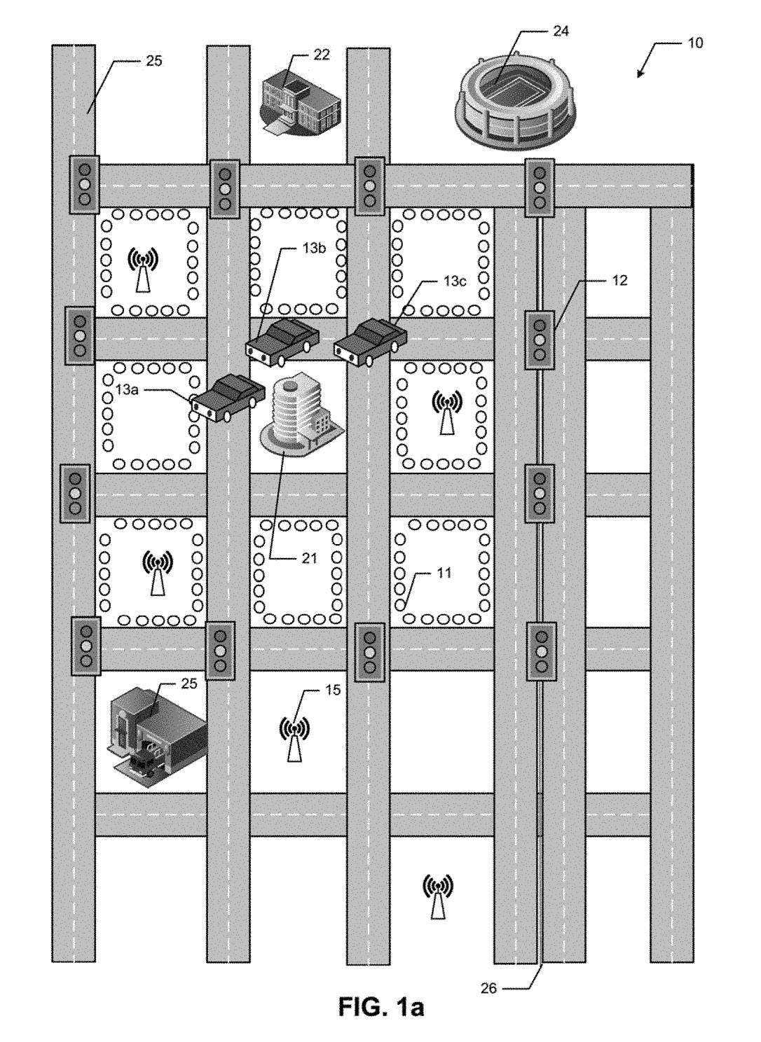

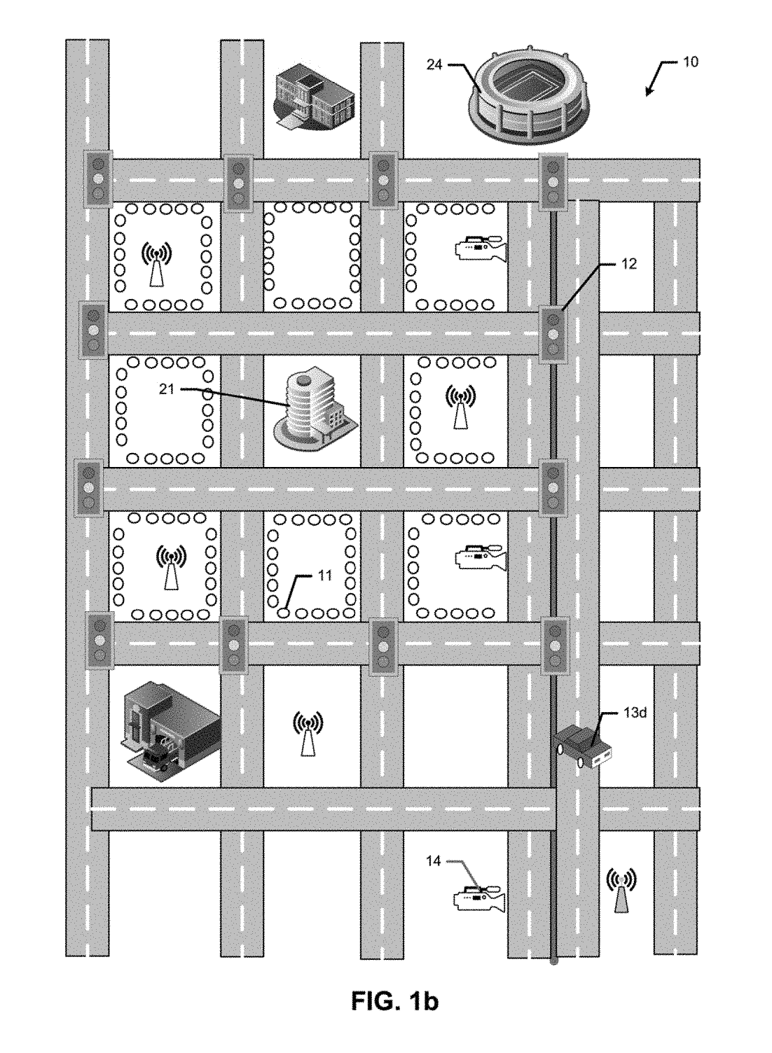

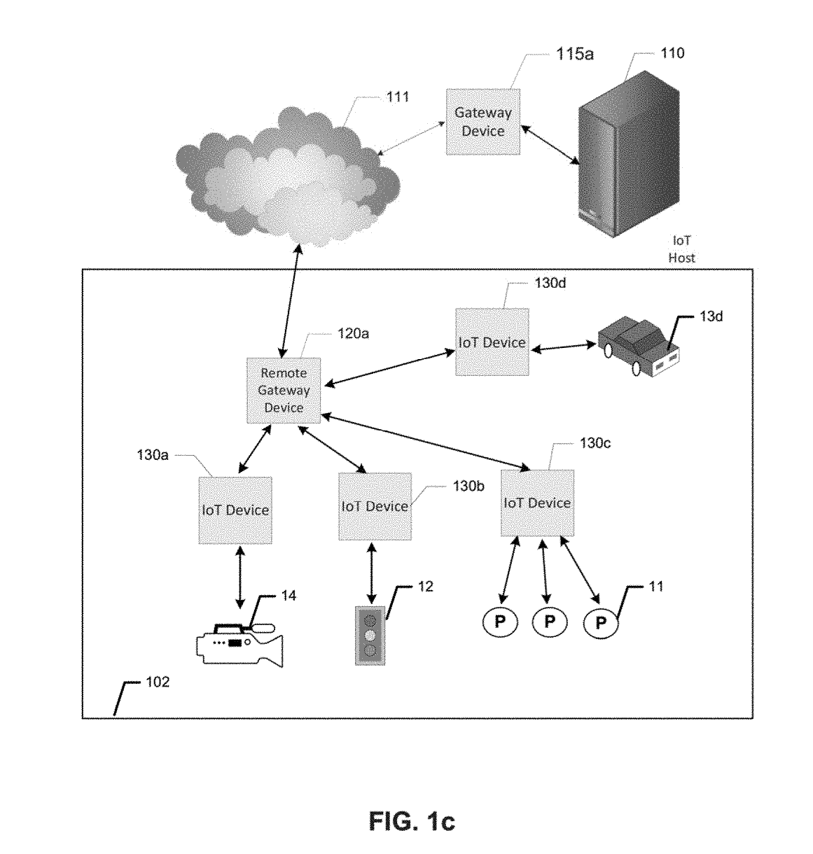

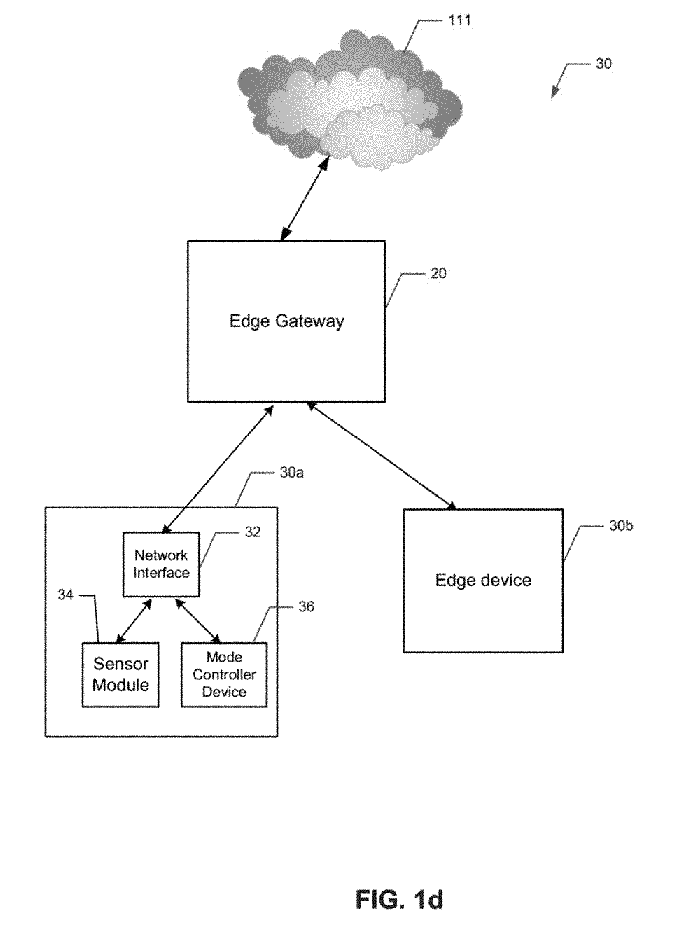

FIG. 1a represents one potential embodiment of a IoT network connecting a plurality of multi-state IoT devices providing smart cities functionality. The creation of IoT devices suggests the possibility to create smart cities in which various devices provided by the city to control areas at various times automatically as well as quickly in response to events. The example embodiment of FIG. 1a-b represent a portion of a city 10 having various multi-state and programmable IoT devices including parking meters 11, traffic lights 12, municipal vehicles 13 a-d, cameras 14, and multiple network wireless access points 15. Each of these devices are coupled to a network 111 via the network wireless access points 15 or directed wired connections. These devices communicate with an IoT host server 110 within a remote data center.

The city 10 may have various locations and structures including an office building 21, fire station 22, school 23, stadium 24, multiple 2-lane roads 25, and divided 4-lane boulevard 26. These locations and structures are meant to be examples of locations that may interact with the IoT devices as described herein. Many other locations and structures are possible for interaction with the disclosed system as recited within the attached claims.

Base Device Operations

Each of the IoT devices shown in FIG. 1a operate in a base or default operating mode as described below. The IoT devices include a network interface 32, a sensor module 34, and a programmable multi-state mode controller 36. Each of these modules are described below in further detail and the operation of the IoT devices are discussed herein. In FIG. 1a, the illustrated IoT devices include parking meter devices 11, traffic control lights 12, municipal vehicles 13a-d, and cameras 14.

In a default operating mode, each of the devices operates according to a predetermined mode. For example, the parking meter devices 11 operate as countdown timers providing a vehicle parked in a space associated with each meter device 11 time to be permissibly parked. A driver may purchase an amount of time using the parking meter IoT device 11 and a time period for parking will begin. When the amount of time purchased has expired, the vehicle, if still in the corresponding parking spot, may be subjected to a parking violation. The parking meter IoT device 11 may communicate with the IoT host server 110 (shown in FIG. 1c), to obtain payment from a credit/debit card processing system in some embodiments. The parking meter IoT device 11 may also communicate with one or more municipal vehicles 13a-d to indicate when the purchase time period has ended and a parking violation may be issued via the IoT host server 110. The parking meter IoT device 11 may also be configured to send a message, such as an e-mail or a text message to the driver as the time remaining on the meter is ending via an application on the IoT host server 110.

The traffic control lights 12 are typically located at the intersection_{—} of two or more 2-lane roads 25 and divided 4-lane boulevards 26 to provide vehicle flow control for drivers operating vehicles within the city. These traffic control lights 12 are typically the red-yellow-green traffic lights that are used throughout the United States that may also possess additional lights to control turning lanes. In a default operating mode, these traffic control lights 12 alternate between red and green light states for each of the roads that they control, passing thru a yellow light state when transitioning from a green light state and a red light state. The traffic control lights 12 may change states, and thus the roads that are permitted to pass thru an intersection, using a timed state approach in which each controlled roadway is in a green state and a red state for predetermined amount of time. The length of time for the red state and the green state may not necessarily be of equal length as expected traffic flow in one direction may be greater than a competing direction. Additionally, the changing of states from a red state to a green state may be triggered by sensors that detect the presence of a vehicle waiting to pass thru an intersection controlled by the traffic control lights 12. The traffic control lights 12 operate in this mode until reprogrammed by commands from the IoT host server 110.

The one or more municipal vehicles 13a-d may communicate with the IoT host server 110 to update the host server with the location of the vehicles at any given moment in time. The IoT host server 110 may transmit messages to the municipal vehicles 13a-d as needed to direct them to a location with instructions regarding action to be taken. One such example is stated above in which a vehicle is instructed to go to a vehicle in which its parking time has expired and has not as of yet left the parking spot. Other municipal employees such as first responders may also be directed to locations in which they are needed. The IoT host server 110 may use the location of the vehicles to determine which responder will arrive the fastest. The municipal vehicles 13a-d may also provide voice communications over the network 111 using a Voice-Over-IP communications protocol between drivers of the municipal vehicles 13a-d and others in the city.

One or more cameras 14 may be located throughout the city to provide periodic images of the areas around each camera to municipal employees monitoring the city via the IoT host server 110. In a default operating mode, these cameras may transmit at a low frame rate, such as a few frames per minute, to minimize the network bandwidth needed to support these images. The cameras 14 may operate at a higher frame rate including a standard video frame rate of 24 or 30 frames per second when an operator has determined that a particular location is of interest.

Planned Events

All of the above devices may also operate in other operating modes to control events occurring within areas of the city. In one embodiment, the IoT devices may be programmed to operate in an alternate operating mode upon command from the IoT host server 110 according to a predetermined schedule. In one possible situation, a planned event may be scheduled to occur in an office building 21 at a known date and time that requires heightened security such as when a head of state or other official is expected to be present in which access to the area near the office building 21 is to be limited. In such a situation, the IoT host server 110 may instruct the IoT devices to operate in an alternate operating mode for some time before the scheduled event and continue until after the event has ended. All of the operating modes may be programmed into configuration data files within the IoT host server 110 and transmitted to the IoT devices at predetermined times.

For example, security for this event may desire to limit all traffic within a nine (9) square block area surrounding the office building 21, may desire to eliminate all parked vehicles from this nine (9) square block area, and may wish to instruct municipal vehicles 13a-d to various locations as the event preparation occurs until the event has ended. The above IoT devices may be set into an alternate operating mode to assist in these plans.

For example, the parking meter devices 11 may be instructed to not sell parking time that would extend into the time period of the event, including any preparation time before the event and any time after the event. The parking meter devices 11 may also begin transmitting messages to drivers informing them of the upcoming event in which their vehicles are not permitted within the nine (9) square block area. The parking meter devices 11 may communicate with municipal vehicles 13a-d, such as tow trucks as the time of the event nears to remove any remaining vehicles.

The traffic light devices 12 may be programmed into a mode that indicates to drivers not to enter into a nine (9) square block area from a starting time 2 hours before the scheduled event. The IoT host server 110 may communicate with each of the IoT traffic signals 12 instructing them to display a defined light pattern that does not change.

The camera devices 14 may be controlled as needed by operators connected to the IoT host server 110 to monitor the area before the event to ensure that all of the preparations occur, to monitor the area to ensure that no unauthorized person or vehicle enters the nine (9) square block area, and to assist in responding to situations that may arise during the event. The frame rate, and thus network bandwidth needed for these activities may change throughout the time when the event is occurring.

As noted in the parent application, the network 111 may be dynamically reconfigured to ensure 100% uptime for the IoT devices communicating with the IoT host server 110. During the above events, the bandwidth needs of various devices may change. For example, during the time leading up to the scheduled event at the office building 21, the traffic light devices 12 may need some amount of bandwidth to reconfigure the IoT traffic signal device 12 for a short period of time. Once the devices are reconfigured, the traffic signals 12 may not need any bandwidth at all until the event ends and they are reset to a default operating mode. Similarly, parking meter devices 11 may require bandwidth during the beginning of the time allotted for preparation for the event to send messages to the vehicle owners to move their vehicles and to municipal vehicles 13a-d as the remaining vehicles are moved. Once the parking spots have been cleared, no network bandwidth may be needed for the parking meter devices 11.

Finally, during the event itself, all of the network bandwidth may be allocated to the camera devices 14 and municipal vehicle 13 communications as security is provided for the event. Host server 110 may reconfigure the operation of the network dynamically as needed to support these remaining IoT devices during the event. Once the event has ended and security is terminated, the network 111 may be reconfigured to a default operating mode in which the traffic signals 12 are configured to change state to control traffic, parking meter devices operate in a default mode to collect parking fees, and camera devices returning to a low frame rate as needed.

Externally Triggered Event

In an alternate situation, consider an unplanned emergency, such as a major fire occurs in the office building 21, instead of a scheduled event. Much of the same changes to the IoT devices to prevent traffic from entering the nine (9 ) square block area, to encourage vehicles parked in the area to leave the area allowing emergency vehicles to access the area, and to permit communications between municipal vehicles 13 coming to the area as well as operating within the area while fighting the fire. The IoT host server 110 may send the commands to each of the above IoT devices as well as reconfigure the operation of the network as needed under the instruction of operators and dispatchers via the IoT host server 110. Once the existence f the fire is detected and passed on to the fire department, operators and dispatchers may interact with a control program on IoT host server 110 to implement any changes to the operation of the IoT devices and the network.

FIG. 1b represents another potential embodiment of a IoT network connecting a plurality of multi-state IoT devices providing smart cities functionality. Consider an unplanned event such as a major snowstorm is making the 2-lane roads 25, and divided 4-lane boulevard 26 impassible. The city may wish to ensure that drivers from locations such as office building 21 and stadium 24 can travel through the area safely on their way home. In such an arrangement, the camera devices 14 may be providing images of the various intersections and roadways to inform dispatchers of the existing conditions. The dispatchers may also communicate with municipal vehicles 13d, such as a truck with a snow plow, to best attempt to remove the snow from high priority roadways such as divided 4-lane boulevard 26 to allow traffic from the stadium 24 to exit the area. The dispatcher may also communicate with traffic signal devices 12 in an attempt to keep traffic flowing only on the cleared areas. By tracking the location of the snow plow vehicle 13d, the host server 110 may change the operation of various traffic signal devices 12 shortly after the snow plow has passed through an intersection.

All of these changes are controlled by the dispatcher communicating with the IoT host server 110 as the snow event is occurring. Once the snow stops falling, the dispatcher may direct the snow plow vehicle 13d to each of the roadways with the high priority roadways plowed first, and once these roadways are observed to be clear, directing the snow plow vehicles to other roadways until all of the roadways have been cleared. Throughout the entire event, host server 110 may be dynamically reconfiguring the network 111 to provide needed bandwidth to individual cameras 14, traffic signal devices 12, and snow plow vehicles 13d to ensure the snow removal process occurs efficiently. The host server 110 may also be monitoring the network 111 and its components as discussed in the parent application to address any network communication issues that may arise if, for example, snow fall has covered wireless access points 16 that are part of the network 111 making some communications difficult or intermittent.

The example of a city disclosed herein is provided as a method of example of possible embodiments of the present invention. A city in the above embodiments may represent any type of contiguous area such as university and business campuses, building complexes, large parks, stadiums, and other similar areas in which control of the area is defined. The example of multi-state devices such as traffic lights, parking meters, municipal vehicles as discussed above are also presented as example multi-state devices usable within the IoT network disclosed herein. Other similar devices may include remotely programmable lock devices, access gates, fire suppression devices, sensors, and other devices having multiple operating states that may be desired into particular states for scheduled and external events similar to the ones discussed herein. The scope of the present invention should be limited only by the limitations contained within the claims attached herein.

FIG. 1c illustrates an IoT Host computer 110 connected to a network 111 that is also connected to an IoT network 102 of IoT edge devices 130a-130f. IoT Host 110 communicates with the IoT edge devices 130a-130d thru one or more gateway devices 115a-115b, network 111, and Remote Gateway devices 120a. Each of the IoT edge devices 103a-130d may be connected to Remote Gateway device 120a to provide multiple communications paths between the IoT edge devices 130a-130c and IoT Host 110. If a device fails in any part of this network, the multiple communication paths provide a mechanism to reestablish communications between the IoT edge devices 130a-130d and IoT Host 110.

While the present invention may make use of any unused IoT hardware to failover to, and could look for this possibility first, it would also gladly use unused bandwidth on an already-being-used IoT hardware component, e.g. path, gateway or edge device, at the time of a failure. Obviously, the more hardware cross-connections and the more available bandwidth that exists in an IoT network, the better, as that provides more failover choices. But once again, the key here is that this present invention obviates the need and cost of having fully redundant standby hardware and communications paths.

Depending on the topology of a particular IoT network and the failing component, there could be different ways in which “100% uptime” could be achieved. In all cases, the solution would choose which secondary component(s) to replace the failing one(s). The strategy used to make any failover decision may be Administrator selectable: it can either be based on detailed, specific topology rules given in advance by the Administrator (Admin) for that particular network operating in an “expert mode” or it can be based on a set of “general” load balancing rules in an “automated” mode that doesn't require Admin rules be given.

Expert mode would allow an Admin who wishes to pre-designate in fine-grained detail which component(s) is to provide backup processing for a particular failing component. For example, for a particular IoT edge device, the Admin could choose to designate which of a set IoT Gateways would take over communications to the device in the event that the device's primary Gateway would fail. Or the Admin could choose which of different alternative paths would be used to an IoT edge device should its primary path fail. This mode would allow more upfront planning & decision making to be designated by the Admin, but would allow for detailed failover strategies tailored to the specific IoT network to be specified by the Admin, to be carried out by the underlying solution implementation.

Automated mode would be a simpler user interface (UI) that does not require detailed input from the Admin and would instead allow him/her to inform the underlying solution of a more general strategy for failover component selection. For instance, in this mode, the Admin might choose a strategy such as “evenly load balancing” where the least busy component is chosen or “round robin” where a failover component would be picked based on the most recent failover choice. These choices would allow the solution to make a reconfiguration choice based on a criteria such as “which of the possible failover components currently has the lightest load” or “choose a failover component different from the one we chose last time”, etc.

Either way, at failure time, the underlying solution will choose component(s) to replace the failing one(s) and then dynamically do the reconfiguration work necessary to reorient the network such that there won't be a service outage. The solution will also report the failure to an IoT Administrator so that the failed component can be scheduled for replacement. In the meantime, service will continue as best as possible, depending on the amount of extra bandwidth available in the chosen replacement component(s) at the time of the failure.

For instance, the ability to failover an IoT gateway 115a, i.e. the main cloud gateway through which IoT traffic from IoT devices funnels into the IoT Host 110, is an example of providing “100% uptime” for one particular component type of an IoT network 102-103. Other IoT component types could fail (via either hardware breakage or software bug) and cause a failure to achieve “100% uptime”. For instance, the failure of a lone data path between an IoT edge device 130d and the IoT Remote Gateway 120a may cause a usage outage. Or, in larger IoT networks that employ multiple levels of gateways “outboard from the cloud,” e g. the AZURE™ model allows for outboard IoT Protocol and IoT Field gateways (not shown), in addition to the inboard cloud IoT Remote Gateway, a hardware or software failure of an outboard gateway could cause an outage.

Additionally, an IoT edge device, that typically comprises a sensor multi-state device as discussed above, may also fail and cause an outage. All of the various pieces of an overall IoT network need to be considered/reconfigured in order to achieve “100% uptime” in the face of various IoT component failures. The present invention identifies failures of any device in an IoT network 102-103 and then chooses appropriate reconfiguration components before dynamically reconfiguring the IoT network to use chosen replacement devices.

Because of the large number of component failure and topology types that may require reconfiguration, rather than trying to design/implement replacement solutions for all of possible failures in one large waterfall model, the present invention breaks down and prioritizes various use cases, then orders the design/implementation of the overall solution to deal first with those use cases believed to be most likely to occur in the field. The actual implementation would consist of an application operating as a service that would most likely run on one or more “highest level” gateway(s) 115a that have visibility to the overall IoT network. The service would direct the initial “primary” configuration of the overall IoT network 102, such as designating which IoT devices 130a-130j are served by which Remote Gateways 120a-120e via which paths during “normal running.”

The service(s) would then monitor the IoT network 102 for outages which would require redirecting to usage of a “secondary” component. For instance, by generating and routing periodic “status” operations through the various paths and gateways to particular devices, the service could monitor the health of the IoT components. If there already exists “known periodic” traffic between the host(s) 110 and IoT edge device(s) 130a-130d, the service could track this traffic and when the service notices that traffic has not been generated for a particular period of time, the service may route its own status ops through the IoT network 102 to quickly ascertain which IoT edge devices 130a-130d or Remote Gateways 120a have failed, choose a replacement device based on how the Administrator specified that replacements would be chosen, do the reconfiguration, i.e. set up the routing in the appropriate gateways and/or devices for whichever gateway, path or device should he used instead of the failing one, and alert, the Client with a notification. This notification may consist of a popup message on a host service screen, an audible alarm, and/or an email/phone call or log entry, etc.

FIG. 1d illustrates an example embodiment of multi-state IoT devices providing smart cities functionality. In this embodiment, an IoT device network 30 includes two edge devices 31a-31b connected to an edge gateway device 20 for communications over network 111. Each edge device 31a-31b contains a network interface 32, a sensor module 34, and a programmable multi-state mode controller 36. The network interface 32 connects edge device 31a to edge gateway 20 using a communications protocol. This communication may be wired or wireless and may utilize any communications protocol. The sensor module 34 is a data generating device such as a sensor or in the above embodiments for example, a camera and parking meter user interface module. The programmable multi-state mode controller 36 is a programmable device that operates in a default mode as discussed above as well as one or more alternate operating modes. The controller 36 implements the logic or instructions necessary to implement the functionality of the IoT device.

Because multiple types of IoT devices as discussed above may share a single communications network 111, it may be desirable to segregate the network communications into separate communities of interest such that entities and operators may only receive data and control operation of the IoT devices when the particular operators are authorized. The various IoT devices may be segregated into separate communities of interest utilizing micro-segmentation of devices into separate conclaves using the STEALTH™ technology created and owned by the Unisys Corporation. Additional details of the operation of micro-segmentation of IoT devices over a shared network is described in more detail in commonly assigned and concurrently pending U.S. patent application: Entezari, entitled MICRO-SEGMENTATION OF AN APPLICATION RUNNING IN AN IoT GATEWAY, Attorney Docket no. TN650, Ser. No. 15/695,359, filed Sep. 5, 2017, currently pending. This application is incorporated by reference herein as if it was recited in its entirety.

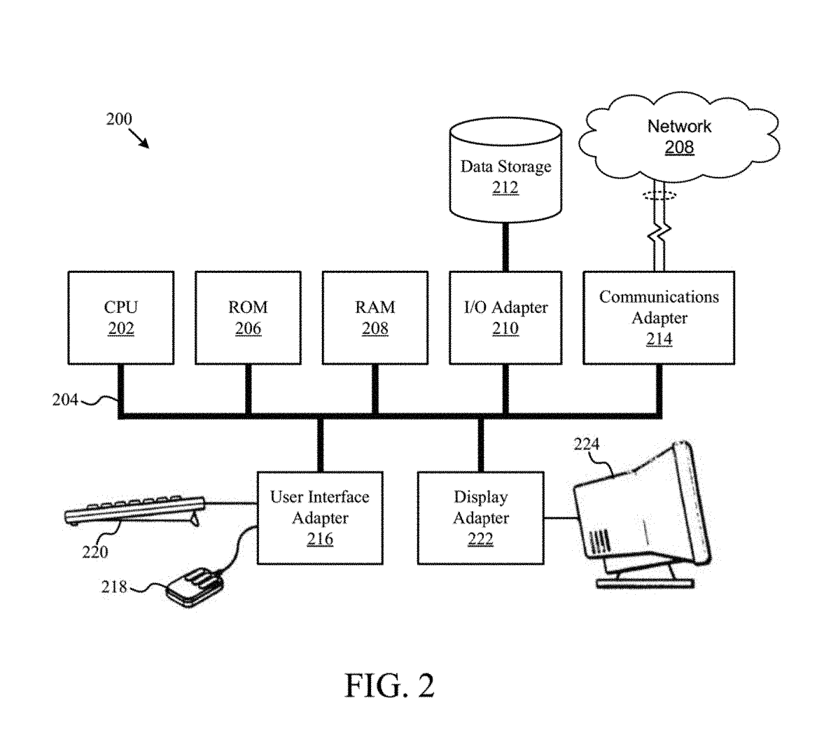

FIG. 2 illustrates a computer system 200 adapted according to certain embodiments of the server 102 and/or the client computer 101. The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 800 may utilize RAM 208 to store the various data structures used by a software application. The computer system 800 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 708, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may he coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 800 is provided as an example of one type of computing device that may be adapted to perform the functions of a server 102 and/or the client computer 101. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

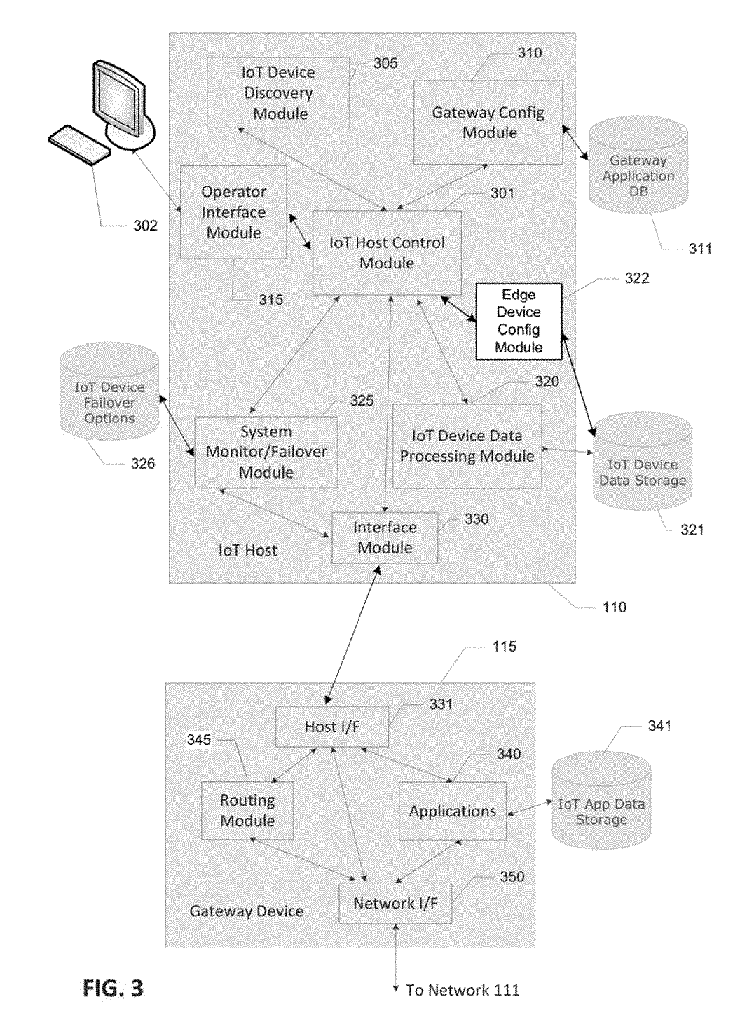

FIG. 3 illustrates an example IoT Host Server and one Gateway device according to another embodiment of the present invention. IoT Host 110 interacts with gateway device 115 to communicate with IoT edge devices via a network 111. IoT Host 110 comprises an IoT Host Control module 301, an operator interface module 315 connected to a user console 302, an IoT device discovery module 305, a gateway config module 310 coupled to a gateway application database 311, an IoT device data processing module 320 coupled to an IoT device data database 321, an edge device multi-mode configuration module 322, a system monitor/failover module 325 coupled to an IoT device failover options database 326, and an interface module 330 coupled to the gateway device 115.

The IoT Host Control module 301 is responsible for configuring, enabling, monitoring and controlling the operations of all of the modules within the IoT Host 110. At start up, the IoT Host Control module 301 configures the operation of the other modules and initiates any necessary interaction between any of these modules and each other as well as Remote Gateway devices and/or IoT edge devices. During operation, the IoT Host Control module 301 monitors the operation of all other functions within the IoT Host 110 and will initiate any needed actions when an anomaly arises. The IoT Host Control module 301 may utilize other modules within the IoT Host 110 to deal with these issues when they arise. Through all of these interactions, the IoT Host Control module 301 will control the operation of the entire system.

The operator interface module 315 connected to the user console 302 provides a mechanism for an operator to observe and control the functions within the IoT Host 110. The operator interface module 315 provides a user interface to control functions and monitoring data within the IoT Host control module 301. The operator interface module 315 provides the data to the operator and accepts commands that start, stop, and alter the operation of the system. The operator interface module 315 provides a communications function to communicate with the user console 302 either as a console directly connected to the IoT Host 110 as well as a remote client executing on a remote computing system that is connected to communications network. One of ordinary skill will recognize that the remote client may either be a client application or a terminal emulation program without deviating from the present invention. Additionally, the operator interface module 315 may communicate with the remote client via network 111, thru interface module 330, or using a separate communications connection between the operator interface module 315 and the remote console.

The IoT device discovery module 305 is responsible for determining the topography of the IoT network 103 as shown in FIG. 1. At network startup, the IoT device discovery module 305 will identify all of the IoT edge devices 130a-f and all of the Remote Gateway devices 120a-c in the IoT network 103. The IoT device discovery module 305 also discovers all of the communications connections and paths between all of the devices in the IoT network 103. From this data, the IoT device discovery module 305 may construct a complete topography of the IoT network 103.

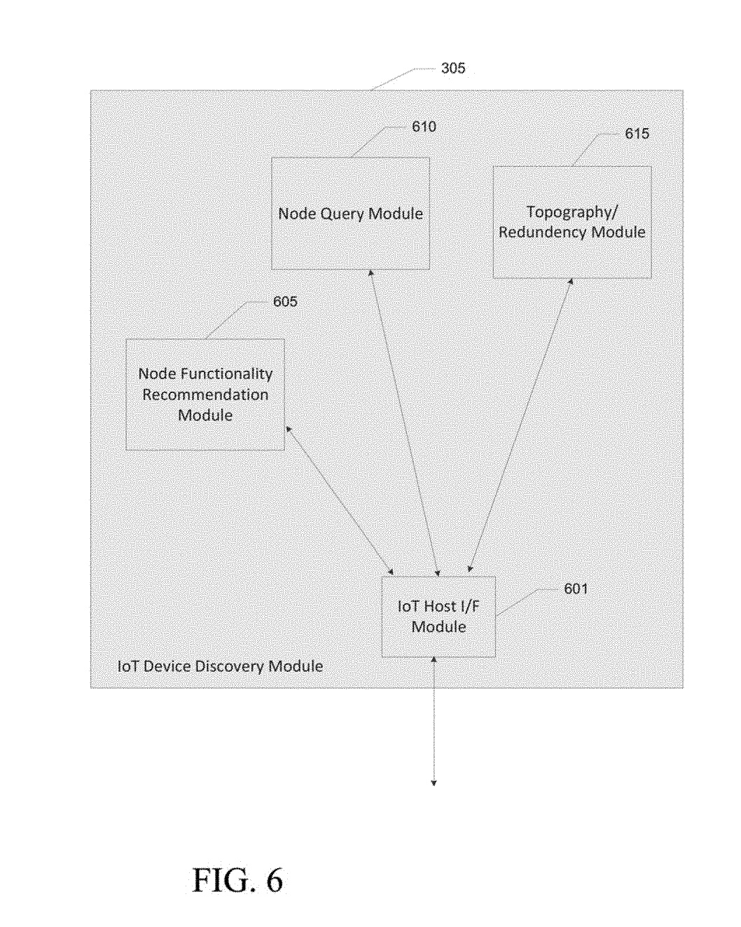

The IoT device discovery module 305 may obtain all the necessary data by sending a discovery request to all of the devices within the IoT network 103. Each of these devices forward the discovery request to all of the devices connected to the device. The devices in IoT network 103 will respond to the first request by returning to the IoT device discovery module 305 its identity, its location, an identity of all of the devices directly attached to the device, and an identifier for every communications link between each of the devices. The IoT device discovery module 305 is discussed in additional detail in reference to FIG. 6 below.

The gateway config module 310 is responsible for configuring the operation of the attached gateway device 115 and the Remote Gateway devices 120a-c. The gateway config module 310 obtains all configuration data and applications that are to be loaded into the various gateway devices and provides the data and applications when a gateway device is either started or reconfigured. The gateway config module 310 is coupled to gateway application database 311 to store all of the configuration data and applications needed in the above processing.

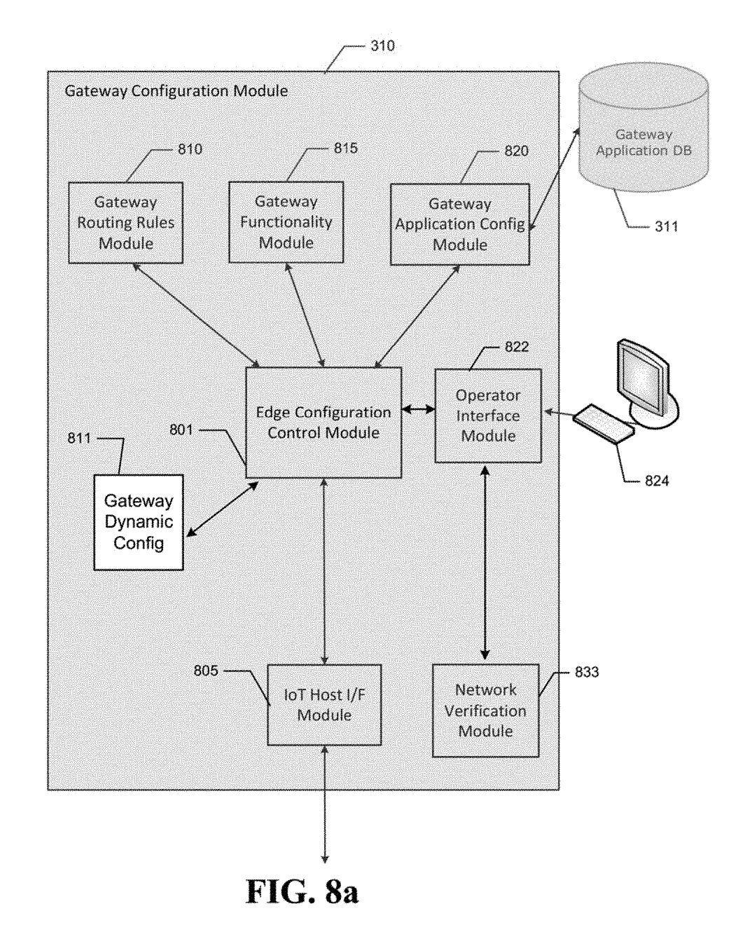

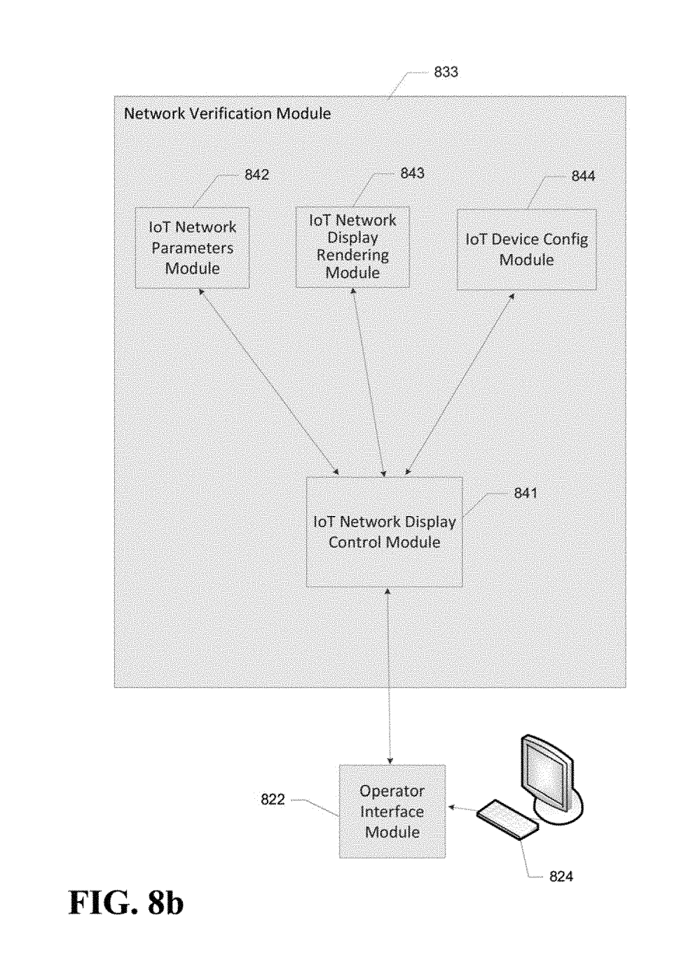

The IoT device data processing module 320 is responsible for obtaining data from the IoT edge devices 130a-f while the IoT network 103 is operating. Depending upon the function of the IoT edge devices 130a-f, the gateway config module 310 may perform processing operations necessary for the IoT network 103 to perform a desired operation. For example, IoT edge devices 130a-f may consist of various sensor devices. The gateway config module 310 may perform data filtering, averaging, and alarm triggering functions based upon the sensor data obtained from the IoT edge devices. The present invention envisions that the gateway config module 310 perform any necessary operations as defined when a system 100 is designed. The gateway config module 310 is coupled to the IoT device data database 321 as attached storage to store and manage any of the data needed to perform the sensor data processing functions. Additionally, log files and other diagnostic data from the operation of the IoT network 103 may be stored in the attached database 321 for retrieval and analysis at a later time. Additional functions and operation of the gateway config module 310 are described below in reference to FIG. 8a.

The edge device multi-mode configuration module 322 is responsible for configuring the operating modes for all of the IoT edge devices 130a-c. As discussed above, edge devices 130a-c may operate a default operating mode and one or more programmable operating modes. The edge device multi-mode configuration module 322 obtains configuration data from the edge devices 130a from the IoT device data database 321 based upon a scheduled event or based upon a dispatcher's input from a user terminal 302 via the operator interface module 315.

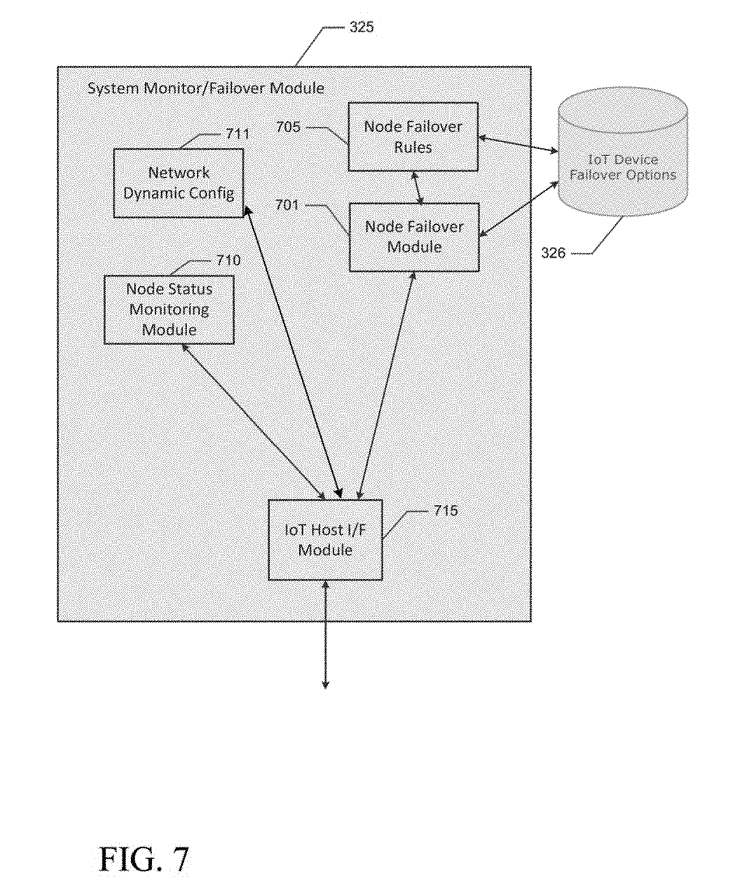

The system monitor/failover module 325 is responsible for detecting an occurrence of an anomaly within the operation of IoT network 103 and for attempting to reconfigure the functions of IoT network 103 and its devices to maintain operation of the IoT network 103. In some embodiments, IoT network 103 may possess redundant IoT edge devices 103 a-f and redundant Remote Gateway devices 120a-c. When one of these types of devices fails or otherwise is not operating as desired, the system monitor/failover module 325 determines the nature of the anomaly, identifies possible replacement device and/or communications paths, and initiates a reconfiguration of devices within IoT network 103. The system monitor/failover module 325 obtains failover options data from the IoT device failover options database 326. The system monitor/failover module 325 may reconfigure the needed devices directly, or may instruct the gateway config module 310 to perform the reconfiguration. In the latter embodiment, the system monitor/failover module 325 may pass to the gateway config module 310 the identity of the devices to be reconfigured and the identity of a configuration role for that device. Additional details regarding the system monitor/failover module 3 may be found below in reference to FIG. 7.

The interface module 330 provides communications for the IoT Host 110 to its local gateway device 115. The interface module 330 permits the communications to flow as required while utilizing a particular protocol and transport mechanism. The interface module 330 prioritizes the communications from all of the modules within the IoT Host 110 to ensure that a priority between possible communications is provided. For example, the interface module 330 may perform communications related to a failover and/or an alarm process that may be considered critical over the routine transmission of IoT edge device data and/or routine status updates. The interface module 330 may implement a priority scheme to ensure that critical issues are resolved before routine operations or any other arrangement desired.

The gateway device 115 comprises a host interface module 331, a routing module 345, an applications module 340 coupled to an IoT application data storage 341, and a network interface module 350. The host interface module 331 performs the converse of the operations of the interface module 330 within the IoT Host 110. Data is transmitted to and from the interface module 330 in the desired protocol over the implemented transport mechanism. The host interface module 331 communicates and coordinates the transfer of data and commands as requested by the interface module 330 to realize any priority scheme discussed above.

The routing module 345 utilizes the network topography for IoT network 103 that is created within the IoT device discovery module 305 and utilizes routing rules from the gateway config module 310 to route communications to and from the IoT edge devices in IoT network 103. The routing module 345 may maintain a routing table that contains a hierarchical routing table that specifies all of the possible communications paths from the IoT Host 110 and any one of the IoT edge devices 130a-f. The table may also provide an order for the path to be chosen to route the communications within IoT network 103. In many embodiments, the routing table data is updated at system configuration and at any or all failover reconfiguration events. In such an embodiment, the routing data is static.

In an alternate embodiment, the routing module may monitor the performance of the IoT network 103 communications as measured in any number of ways to identify parts of the network that may be experiencing higher levels of message traffic and in such cases, choose alternate communications paths to attempt to balance the communication load on all of the affected communications paths. The routing module 345 may attempt to measure these message traffic levels by examining any observed latency in the gateway device 115 receiving acknowledgement of messages and commands. The routing module 345 may use an indication of the number of pending messages and commands within any communications buffers within the network 103 to approximate message traffic loads.

The applications module 340 supports any application functions requested during configuration to process data from IoT edge devices before the data is forwarded to the IoT Host 110. As noted above, data from the IoT edge devices may represent time sampled data from sensor devices that may require filtering, averaging, and other similar processing before the sensor data may be useful. The gateway devices 115 and Remote Gateway devices 120a-c are envisioned to be programmable computing devices possibly within the network infrastructure. These devices typically possess unused computational capacity and may be sized to provide a desired level of computational capacity, to permit the large amount of data that is expected to be generated by a network of IoT edge devices to be efficiently processed at the various gateway devices within the IoT network 103 while reducing the amount of data that needs to be communicated through the network to the IoT Host 110. The applications module 340 may use the IoT application data storage 341 to store, organize and maintain data from its processing of the IoT edge device data for use at a later date when necessary.

Additionally, applications module 340 may utilize a Docker containerized application that permits an application to execute as a self-contained virtual computing system that implements the desired application function. The container may include an application and a small OS kernel including any needed function libraries to permit the application to function. The Remote Gateway device 120a-b may permit these containers execute as a virtual computing device within itself to implement any desired functionality. Because a container may be launched within any device supporting these virtual computing applications and also contain any application written and configured to execute within the container, any functionality needed may be supported within a gateway device 115, 120. Additionally, the functionality of the gateway device may be altered by starting a new containerized application within a gateway device. The new application may either replace an existing application or add an additional application to the gateway device. The number of virtual applications that may exist within a given gateway device is limited by the computing resources of the gateway devices. Large numbers of virtualized applications within these containers may be supported by a single computing system if there is sufficient memory, network bandwidth, and CPU support to provide the processing needed by these applications. Gateway devices may be implemented with computing components to support these requirements.

The network interface module 350 provides an interface between the gateway device 115 and the main communications network 111. Because this network 111 may include both private and public networks, thee network interface module 350 may also provide security between itself and a corresponding Remote Gateway module 120a-c over these more generally accessible data networks. One of ordinary skill will also recognize that the security functionality may also he located elsewhere in the IoT Host 110 should the communications between the IoT Host 110 and the gateway device 115 also utilize accessible communications networks.

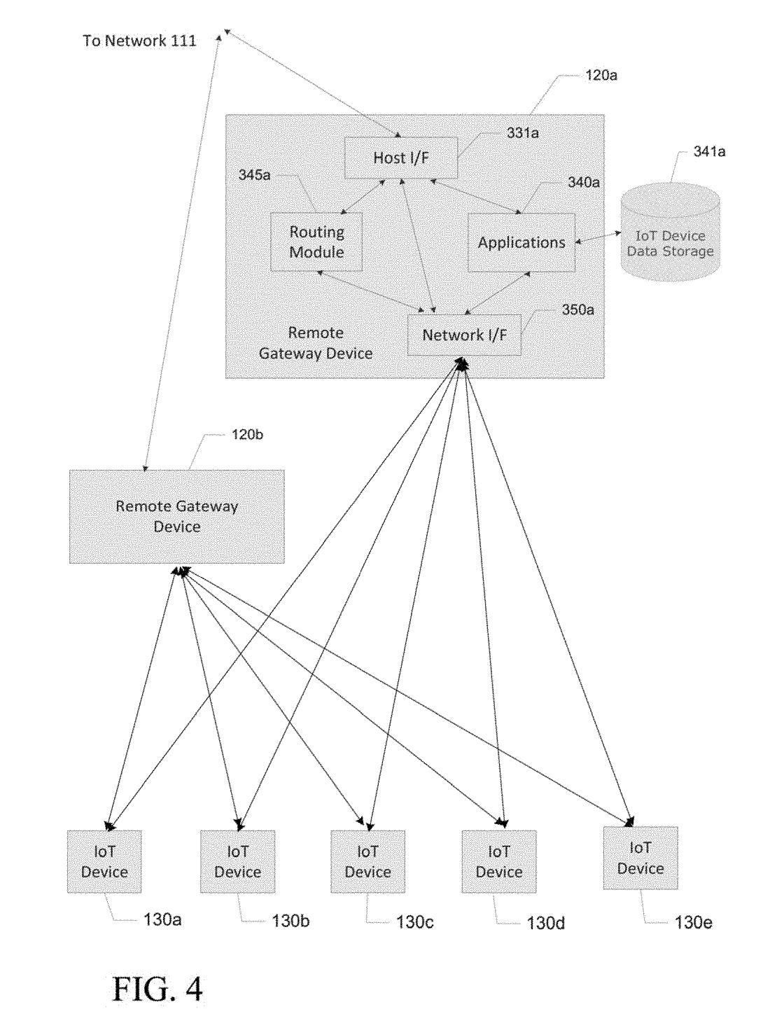

FIG. 4 illustrates an example of Remote Gateway devices and plurality of IoT devices in the IoT network according to yet another embodiment of the present invention. Within IoT network 103, multiple Remote Gateway devices 120a-b may be included to support a large number of IoT edge devices 130a-e. In the embodiment of FIG. 4, two Remote Gateway devices 120a-b are shown supporting five IoT edge devise 130a-e. Both of the Remote Gateway devices 120a-b are connected to the network 111 for communications to the IoT Host 110 via the Remote Gateway device 115 attached to the host 110. Additionally, both Remote Gateway devices 120a-b are also connected to all five MT edge devices 130a-e. When the IoT Host 110 communicates with one of the IoT edge devices 130a-e, the message traffic may be transmitted via either Remote Gateway device 120a-b with the utilized Remote Gateway device using its connection to the particular IoT edge device 130a-e. Should one of the remote gateway devices 120a-b or one of their connections to the particular IoT edge device fail, an alternate path may be used via the other Remote Gateway device. The number of multiple communications paths and thus alternate ways of communicating between the IoT Host 110 and the IoT edge devices depend upon the network topography of IoT network 103 and the number of devices existing in parallel.

In a typical embodiment in which the IoT edge devices comprise sensors, the number of Remote Gateway devices 120a-b and whether the particular gate device connects to an individual IoT sensor may also depend upon the type of sensor within the IoT edge device, the physical location of the IoT sensors, the amount of data to be transmitted by the IoT sensor, and any number of other factors. If the sensors are measuring conditions across a large physical space, the number and location of the sensors may determine the connections and number of Remote Gateway devices used as well as the cost in installing the sensors and connections to the Remote Gateway devices.

The connections between the Remote Gateway devices 120a-b and the IoT edge devices 130a-e may be implemented using any type of communications protocol and communications transport, that is supported by both the Remote Gateway devices and the IoT edge devices. These connections may be wired connections or wireless connections that may implement secure or unsecure communications as needed by the implementation. Examples of protocols that may be supported: Wifi, LoRaWAN, wired Ethernet, serial, Bluetooth, Zigbee, 4G Cellular, and fiber channel connections.

Within each Remote Gateway device 120a-b, the devices include a host interface module 331, a routing module 345, an applications module 340, and a network interface module 350. The Applications module 340 may be coupled to an IoT application data storage database 341. All of these modules perform the functions described above with respect to the gateway device 115 of FIG. 3. Each of these Remote Gateway devices 120a-b control the portion of the IoT network 103 within its connections. In addition, alternative embodiments, may utilize multiple levels of Remote Gateway devices when appropriate because of the number of connections, the geographic locations to be covered, and similar factors that relate to design of a network. The Applications module 340 also supports the Docker containerized application functionality described above in reference to FIG. 3.

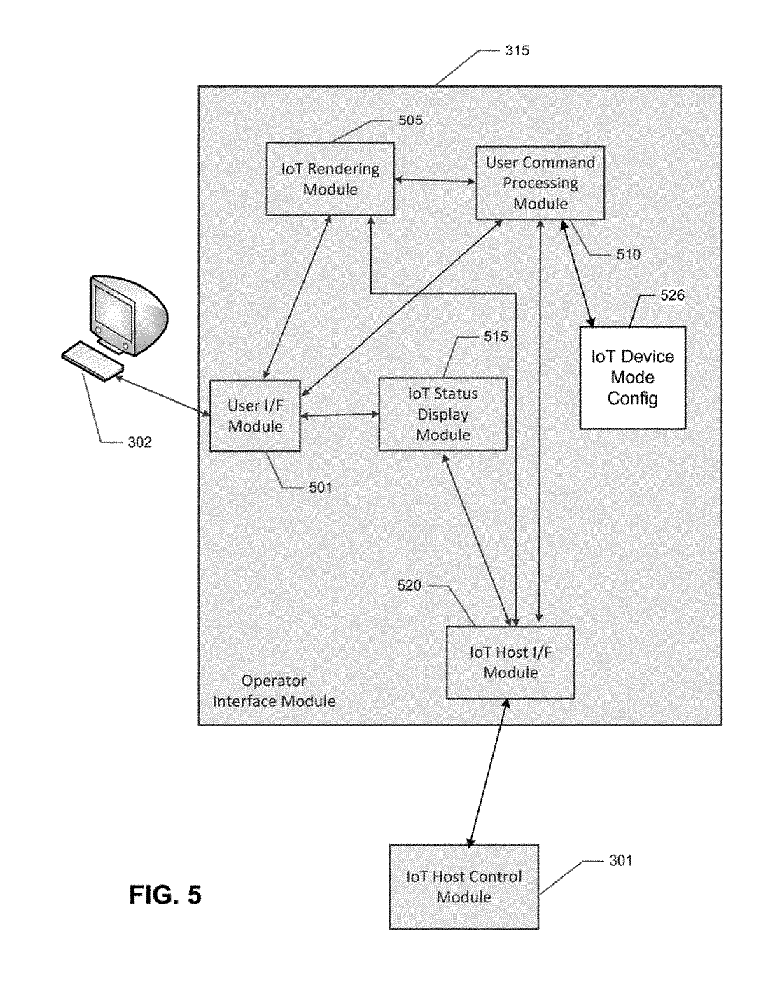

FIG. 5 illustrates an example operator interface module within the IoT Host server according to an embodiment of the present invention. The Operator Interface module 315 includes an IoT Host Interface module 520, an IoT Status Display module 515, an IoT edge device mode configuration module 526, a User Interface module 501, an IoT Rendering module 505, and a User Command Processing module 510. The User Interface module is connected to a user console 302 to display data to an operator and to accept inputs to initiate commands.

The IoT Host-Command interface module 520 is connected to the IoT Host Control module 301 to provide a connection from the user console 302 to the operation of IoT Host 110. The IoT Host-Command Interface module 520 also connects to the IoT Status Display module 515, the User Interface module 501, the IoT Rendering module 505, and the User Command Processing module 510 within the Operator Interface module 315 for facilitating the interaction of the IoT Host 110 and all of the functions supported by the Operator Interface module 315.

The IoT Status Display module 515 prepares a display of the current status of the IoT network 103 and its devices to the user console 302. The IoT Status Display module 515 obtains the status information from the IoT Host Control module 301 and formats the data to match a user interface (UI) that is to be presented on the user console 302. The IoT Status Display module 515 communicates with the user console 302 via the User Interface module 501.

The User Interface module 501 provides a communications interface between the Operator Interface module 315 and the user console 302. The module 501 provides the data formatting for the protocol and transport mechanism needed to communicate with the user console 302. As such, all of the modules in the Operator Interface module 315 may communicate with the user console 302 regardless of the type of connection used to communicate with the user console 302. As noted above, the connection may be a wireless connection, a network connection, and a direct wired connection.

The IoT Rendering module 505 prepares a display of the current topography of the network 103 and its devices. The IoT Rendering module 505 also prepares for display to an operator an indication of the operating mode for each IoT edge device. The IoT Rendering module 505 obtains the status information from the IoT Host Control module 301 and formats the data to match a user interface (UI) that is to be presented on the user console 302. The IoT Rendering module 505 communicates with the user console 302 via the User interface module 501.

The User Command Processing module 510 receives commands initiated by an operator via the user console 302 and generates all necessary requests to other modules within the IoT Host 110 to implement the command. The user command processing module 510 communicates with the user console 302 via the user interface module 501. The user command processing module 510 communicates with other modules within the IoT Host 110 via the IoT Host-Command Interface module 520. In most commands, the User Command Processing module 510 will communicate with the IoT Host Control module 301 when initiating the user commands; however, one of ordinary skill in the art will recognize that the User Command Processing module 510 may directly communicate with any module within the IoT Host 110 to initiate a command. When a command is associated with a change in an operating mode for an IoT edge device 130a, the User Command Processing module 510 communicates with the IoT edge device mode configuration module 326 to generate the necessary configuration data to be sent to the IoT edge devices to change their operating modes.

The IoT edge device mode configuration module 526 generates the necessary configuration data to be sent to the IoT edge devices to change their operating modes. The IoT edge device mode configuration module 526 may obtain configuration data that has been stored within the IoT application data storage database 341 or generate the configuration data as needed.

FIG. 6 illustrates an IoT Edge Device Discovery within the IoT Host server according to another embodiment of the present invention. The IoT Edge Device Discovery module 305 communicates with all of the devices in IoT network 103 to determine the status and topography of the network. The IoT Edge Device Discovery module 305 contains a Node Query module 610, a Topography/Redundancy/Mode Module 615, a Node Functionality Recommendation module 605, and an IoT Host interface module 601.

The Node Query module 610 at start up sends out a broadcast command to all of the devices within the IoT network 103 requesting its identity, its connected devices, and its status. Each of these devices forward the discovery request to all of the devices connected to the device. The discovery request will possess an ID or timestamp so that these devices may recognize when they are receiving multiple copies of the same request. The devices may only forward the first occurrence of the discovery request while ignoring the later requests. As such, the discovery request will eventually be received by all of the devices within IoT network 103.

The devices in IoT network 103 will respond to the first request by returning to the IoT device discovery module 305 its identity, its location, an identity of all of the devices directly attached to the device, and an identifier for every communications link between each of the devices. The IoT device discovery module 305 may also receive other status information regarding the devices health and operating status. All of the received data is then made available to the Topography/Redundancy Module 615.

Using all of the received data, the Topography/Redundancy Module 615 may construct a topography graph for the IoT network 103. The topography graph may be maintained within the topography graph to permit the IoT Host control module 301 or the operator interface module 315 to obtain a current status for all of the devices and connection paths within IoT network 103. The Topography graph contains all of the devices in the IoT network 103, all of the connections between these devices, and is organized into a traversable graph that illustrates every communications path from the IoT Host 110 and every IoT Edge Device 130. The Topography/Redundancy Module 615 identifies a primary communications path and all possible alternate communications paths to each IoT Edge Device 130.

The Node Functionality Recommendation module 605 utilizes the topography graph created in the Topography/Redundancy/Mode Module 615 to determine what, if any, applications may be needed in each of the Remote Gateway devices 120 to support the IoT edge devices as well as the operating modes, both default and alternate operations. The Node Functionality Recommendation module 605 may use the number of IoT edge devices 130 that are connected to a particular Remote Gateway Device 120 to determine whether an application is best located at that Remote Gateway Device, or is best located at a higher or lower Gateway Device between the IoT Edge Device 130 and the IoT Host 110. Other factors in determining the applications needed by each of the Remote Gateway Devices 120 may include, the number of device types contained within primary communications paths thru the particular Gateway Device, an estimated amount of message traffic and corresponding data to be passing thru the particular Gateway Device, an estimate of the processing requirements for the estimated amount of traffic and data, and the resources available in other Remote Gateway devices. These recommendations may be made available to the Gateway Config Module 310 for use in configuring all of these devices.

The Host-Topography interface module 601 is connected to the IoT Host control module 301 to provide a connection from the Topography/Redundancy Module 615 to the IoT Host 110. The Host-Topography interface module 601 provides the data formatting for the protocol and transport mechanism needed to communicate with the IoT Host Interface Module 330. As such, all of the modules in the IoT Edge Device Discovery may communicate with the IoT Host 110 regardless of the type of connection used to communicate with IoT Host 110.

FIG. 7 illustrates a System Monitor/Failover module within the IoT Host server according to an embodiment of the present invention. The System Monitor/Failover module 325 actively monitors the status of all of the Remote Gateway Devices 120 and all of the IoT edge Devices 130 that are part of the IoT network 103. The System Monitor/Failover module 325 obtains the topography of IoT network 103 from IoT Host Discovery module 305 as well as the primary and alternate communications paths from IoT Host 110 and each of the IoT Edge devices 130. The dynamic reconfiguration module 711 determines a default operating mode for each IoT edge device as well as alternate operating modes used by operators for scheduled and non-scheduled events as discussed above.

The System Monitor/Failover module 325 may monitor the status of the devices by monitoring the message traffic that returns to the IoT Host 110 to identify a period of time in which one or more of the devices have not responded that may be greater than a predetermined value. The System Monitor/Failover module 325 may then, or as an alternative to monitoring traffic, may ping each device with a status query message. Failure to receive a response to the query may be used to indicate a failure. The System Monitor/Failover module 325 may attempt to communicate with all of the other devices in a particular communications path to isolate the one or more devices that are failing as well as determine if the failure is related to on communications link between two devices where the devices are otherwise operating.

In other embodiments, Remote Gateway devices 120 may be tasked with the responsibility to monitor the attached IoT Edge devices 130 using a containerized application. This application may transmit the failure information to The System Monitor/Failover module 325 to initiate further failover processing. The System Monitor/Failover module 325 includes a Host-Failover Interface module 715, a Node Status Monitoring module 710, a Node Failover module 701, a Node Failover Rules module 705, and an IoT Device Failover Options database 326 coupled to the Node Failover module 701 and the Node Failover rules module 705. This application may also perform processing needed to support any default and alternate operating modes for IoT edge devices.

The Host-Failover Interface module 715 is connected to the IoT Host control module 301 to provide a connection from the System Monitor/Failover module 325 to the IoT Host 110. The Host-Failover Interface module 715 provides the data formatting for the protocol and transport mechanism needed to communicate with the IoT Host Interface Module 330. As such, all of the modules in the Host-Failover Interface module 715 may communicate with the IoT Host 110 regardless of the type of connection used to communicate with the IoT Host.

As discussed above, the Node Status Monitoring module 710 may monitor the operating status of each of the devices in IoT network 103 in multiple ways. The Node Status Monitoring module 710 implements the chosen monitoring mechanism, determines the failure in as much detail as is possible, and initiates a failover operation.

The Node Failover module 701 performs a failover operation once identified by the Node Status Monitoring module 710. The Node Failover module 701 determines all of the functions to be provided by the failed device, determines one or more possible reconfiguration of the devices within IoT network 103, and initiates a reconfiguration of the effected devices to implement the reconfiguration. The Node Failover module 701 interacts with the Node Failover Rules module 705 when identifying the type of reconfiguration to be implemented. For example, if IoT network 103 possesses an available inactive backup device for the failed device, the Node Failover Rules module 705 may instruct the Node Failover module 701 to utilize the available device. Similarly, if IoT network 103 possesses multiple communications paths to all of the IoT Edge devices 130 that correspond to a no longer working communications path that went thru a failed Remote Gateway device 120, the Node Failover Rules module 705 may instruct the Node Failover module 701 to reconfigure the primary communications paths to be used to support the IoT Edge devices 130. When the reconfiguration of a Remote Gateway device or the communications paths passing thru the Remote Gateway occurs, any containerized applications within the failed Remote Gateway device may need to be added to other devices taking over its function. The Node Failover module 701 ensures that all of these operations are successfully implemented.

In one embodiment, the Node Failover module 701 may communicate with the Gateway Config module 310 to request the reconfiguration operation to occur. The reconfiguration of devices and primary communications paths are similar to the initial configuration of these devices at startup that is performed by the Gateway Config module 310. In an alternate embodiment, the Node Failover module 701 may directly communicate with the devices to be reconfigured in a manner that is similar to the original configuration to ensure that the reconfiguration takes into account the current operations being performed with the devices to be reconfigured. In the latter case, the Node Failover module 701 may obtain any data and containerized applications needed for the reconfiguration operations from the Gateway Config module 310.

The Node Failover Rules module 705 processes a set of reconfiguration rules from a set of rules in the IoT Device Failover Options database 326 that it determines are applicable to the type of failover situation that has been detected. By processing the applicable set of rules, a failover configuration is returned to the Node Failover module 701 for implementation.

Both the Node Failover module 701 and the Node Failover rules module 705 access the database 326 to identify alternatives for the device that has failed. The database 326 may contain information regarding the devices in IoT network 103, the functions performed by each of these devices, the containerized applications that may be used in Remote Gateway devices 120 to support particular IoT edge devices 130 attached to each of the Remote Gateway devices 120, as well as failover options corresponding to one or more of the expected configuration options for all of the devices within IoT network 103.

FIG. 8a illustrates a Gateway Config module within the IoT Host server as an example embodiment of the present invention. The Gateway Config module 310 generates all of the configuration data, containerized applications, primary and alternate communications paths, and gateway device functionality required to configure all of the devices within IoT network 103. The Gateway Config module 310 includes a Gateway Config Control module 801, an IoT Host-Config Interface module 805, an Operator Config Interface module 822, an IoT Network User Config/Present module 833, a Gateway Routing Rules module 810, a Gateway Functionality module 815, a dynamic gateway reconfig module 811, and a Gateway Application Config module 820 coupled to a Gateway Application database 311.

The Gateway Config Control module 801 defines the functionality of the Remote Gateway devices 120 within the IoT network 103 in cooperation with the Gateway Routing Rules module 810, the Gateway Functionality module 815, and the Gateway Application Config module 820. The Gateway Config Control module 801 also interacts with the Operator Config Interface module 822, and the IoT Network User Config/Present module 833 to permit a user from providing input o assist in defining the desired functionality of the devices in the IoT network 103. The Gateway Config Control module 801 receives the network topography obtained from the Topography/Redundancy Module 615, the primary and alternate communications paths within the IoT network 103 from Gateway Routing Rules module 810, the functionality to be located within each of the Remote Gateway devices 120 from the Gateway Functionality module 815, and the containerized applications to be used within the Gateway devices 120 from the Gateway Application Config module 820,

Using all of this data, the Gateway Config Control module 801 creates a set of configuration data for the devices in the IoT network 103. The module 801 uploads all the configuration data and containerized applications to the devices in the IoT network 103 and when all are configured, initiates the enabling of the devices to begin operation.

The IoT Host-Config interface module 805 is connected to the IoT Host control module 301 to provide a connection from the Gateway Config module 310 to the IoT Host 110. The IoT Host-Config interface module 805 provides the data formatting for the protocol and transport mechanism needed to communicate with the IoT Host Interface Module 330. As such, all of the modules in the IoT Host-Config Interface module 805 may communicate with the IoT Host 110 regardless of the type of connection used to communicate with the IoT Host.

The Operator Config Interface module 822 provides a communications interface between the Operator Config Interface module 822 and the user config terminal 824. The module 822 provides the data formatting for the protocol and transport mechanism needed to communicate with the user config terminal 824. As such, all of the modules in the Gateway Config module 310 may communicate with the user config terminal 824 regardless of the type of connection used to communicate with the user console 302. As noted above, the connection may be a direct connection, a networked connection, a wired connection or a wireless connection. Additionally, the Operator Config Interface module 822, in alternate embodiments, may communicate with the user console 302 used to control the operation of the IoT Host 110.

The IoT Network User Config/Present module 833 assists a user to configure the IoT network 103 by presenting the user with a representation of a configured IoT network with an ability to vary one or more defining parameters. A user may view a proposed topography for the IoT network 103 and the functionality of the Edge devices 130 as well as the functionality of the Remote Gateway devices 120 to determine if system requirements may be met. The user may vary one or more of the defining parameters and the IoT Network User Config/Present module 833 modifies the display of the proposed IoT network 103 as affected by the parameter modification.

The Gateway Routing Rules module 810 defines the primary and secondary communications paths to be used within the IoT network 103. The Gateway Routing Rules module 810 utilizes the network topography obtained from the Topography/Redundancy Module 615 and its internal rules to determine the primary communications paths for each of the IoT Edge devices 130 to the IoT Host 110. The Gateway Routing Rules module 810 may select the primary communications path by determining the communications path from the IoT Edge device to the IoT Host 110 using a selection criteria. The selection criteria fray include the most direct path, the path having the fewest connections, the path having the lowest latency as measured by a determination using the communications bandwidth and estimated message traffic, or a multi-level priority scheme that ensures priority to message traffic depending upon the function of the IoT Edge device 130 and/or the functionality present in a Remote Gateway device 120 in the communications path. Additionally, the Gateway Routing nodule 810 may also include a process to check the status of all primary and alternate communications paths by forcing message traffic thru each path in order to determine its status. This process may use a round robin, least recently used, and similar methodologies to determine which of the communications paths may be tested at any given time.

AU of the identified non-primary communications paths will then be considered alternate paths for use in reconfiguration. Also, a primary communications path may consist of two different identified communications paths that both transport message traffic based upon a real-time estimate of the latency and message congestion present in the multiple paths. The primary communications paths may be determined to support the fastest communications or the use of a minimum number of devices or some combination of both approaches as needed to support the performance of the IoT network 103.

The Gateway Functionality module 815 defines the functionality to be located within each of the Remote Gateway devices 120 to support the needs of the IoT network 103. The Gateway Functionality module 815 utilizes the network topography obtained from the Topography/Redundancy Module 615, the primary communications paths for each of the IoT Edge devices 130 to the IoT Host 110 from the Gateway Routing Rules module 810, and its own internal rules to define the functionality for each Remote Gateway device 120. The Gateway Functionality module 815 may select functions needed by determining the data processing needs for data received from the IoT Edge devices 130 before passage to the IoT Host 110 using a selection criteria. The selection criteria may include the number, type, and functions of the IoT Edge devices 130, the available containerized applications from the Gateway Application Config module 820, the processing capacity of each Remote Gateway device 120 present within each primary communications path between the IoT Edge devices 130 to be supported by the Gateway device, and the availability of other Remote Gateway devices 120 that are available for load sharing. Once the functionality is defined, the processing communicates with the Gateway Application Config module 820 for identification of the containerized applications to be used in configuring the Remote Gateway devices 120.

The dynamic gateway reconfig module 811 processes any requests to reconfigure the network to assign more bandwidth to one set of IoT devices and less bandwidth to a second set of IoT devices based upon the current operating mode for each of the IoT devices.

The Gateway Application Config module 820 determines the containerized application to be used in the Remote Gateway devices 120 to provide the needed functionality of the gateway devices. The Gateway Application Config module 820 is coupled to the Gateway Application database 311 to obtain the possible applications needed to implement the gateway functionality as defined within the Gateway Functionality module 815. The Gateway Application Config module 820 and the Gateway Application database 311 may possess all of the containerized applications available for use in the IoT network 103. If the requirements for the Remote Gateway device's applications depend upon characteristics of the individual Remote Gateway device such as support for a particular operating system or version of a Gateway device, the Gateway Application database 311 may contain the needed versions for an application for each of these possible variations.

FIG. 8b illustrates an IoT Network User Config/Present module within the IoT Host server as an example embodiment of the present invention. The IoT Network User Config/Present module 833 assists a user to configure the IoT network 103 by presenting the user with a representation of a configured IoT network with an ability to vary one or more defining parameters. These parameters may include, the number of device types contained within primary communications paths thru the particular Gateway Device, an estimated amount of message traffic and corresponding data to be passing thru the particular Gateway Device, an estimate of the processing requirements for the estimated amount of traffic and data, and the resources available in other Remote Gateway devices. These parameters may also include the most direct communications path, the communications path having the fewest connections, the communications path having the lowest latency as measured by a determination using the communications bandwidth and estimated message traffic, or a multi-level priority scheme that ensures priority to message traffic depending upon the function of the IoT Edge device 130 and/or the functionality present in a Remote Gateway device 120 in the communications path, and any other factor used in the routing and application configuration.

The IoT Network User Config/Present module 833 includes an IoT Network Display Control module 841, an IoT Network Parameters module 842, IoT Network Display Rendering module 843, and an IoT Device Config module 844. The IoT Network Display Control module 841 is coupled to the Operator Interface module 822 to provide display data to the user terminal 824 and to receive user commands from the user terminal 824 to modify the defining parameters of the IoT network 103. The IoT Network Display Control module 841 also coordinates the processing of the other modules within the IoT Network User Config/Present module 833 to generate the proposed topography for the IoT network 103 and the functionality of the IoT Edge devices 130 as well as the functionality of the Remote Gateway devices 120. The IoT Network Display Control module 841 receives user commands and processes them to change the defining parameters for IoT network 103 and it proposed configuration.

The IoT Network Parameters module 842 presents the defining parameters for IoT network 103 to the user via the user terminal 824 in a graphical form. The user may interact with the defining parameter settings to change the configuration of the IoT network 103. The IoT Network Display Control module 841 may display any or all of the defining parameters grouped into logical collections of similar parameters. Each defining parameter may be represented by a graphical user interface object such as a user controlled slider, a user modifiable numeric value, a user controlled dial or similar user interface object that permits the modification of each defining parameter within a predefined range of values. Once the user modifies one or more defining parameters, the IoT Network Display Control module 841 receives the updated parameters and causes the proposed topography and device functionality to be updated.

The IoT Network Display Rendering module 843 generates a visual representation of the topography and device functionality for the proposed IoT network 103 using the current values for the defining parameters and presents the visual representation to the user on the user terminal 824. Each time the defining parameters are updated, the IoT Network Display Rendering module 843 generates a new visual representation of the topography and device functionality for the proposed IoT network 103.

The IoT Device Config module 844 generates all of the configuration data for the devices within the network 103 once the user is satisfied with the topography and device functionality for the proposed IoT network 103. The module 844 may perform the configuration directly or using the Gateway Config module 310 discussed in reference to FIG. 8a. The configuration data and corresponding containerized applications may be uploaded to the devices within IoT network 103 to initiate operation of the network.

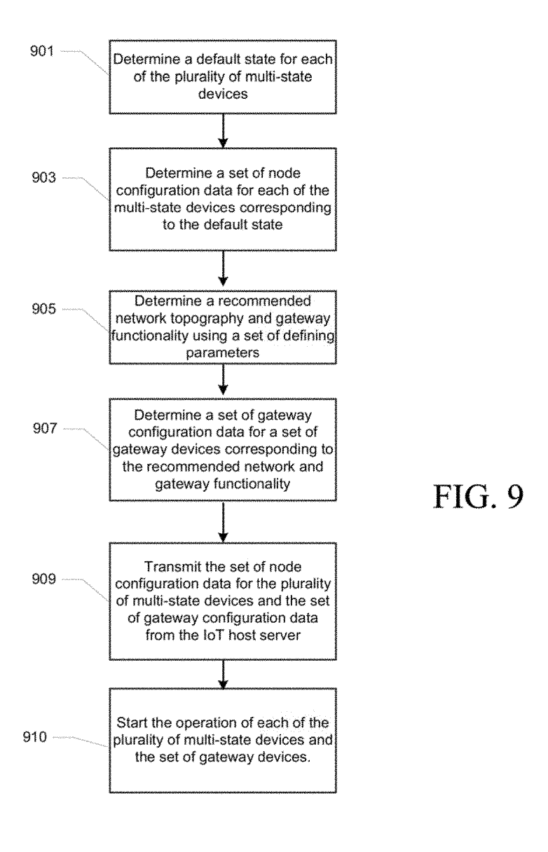

FIG. 9 illustrates a flowchart of possible operations that may be performed according to an embodiment of the present invention. The sequence of operations of FIG. 9 correspond to the operation of network of multi-state edge devices of FIG. 1-8 above when the edge devices are operating in a default state. The process begins in block 901 in which a default operating state is determined for each of the multi-state edge devices. In block 903, a set of configuration data is generated for each of the multi-state edge devices that will place the devices into the default operating state.

Block 905 determines a recommended network topography and edge gateway operating parameters to support network communications when he edge devices are operating in the default state. Block 907 then generates a set of configuration data for the edge device network modules and the edge gateways to generate the recommended network topography and edge gateway operating parameters.

All of the above generated configuration data is transmitted by the IoT host server to the edge devices and edge gateways in block 909. Once all of the data is in place in the devices, block 910 starts the operation of the devices that causes the network of IoT devices and its network to operate in its default state. The network and devices remain in this default operating state until the detection of a detected event in which a new operating state corresponding to the requirements of the detected event are generated.

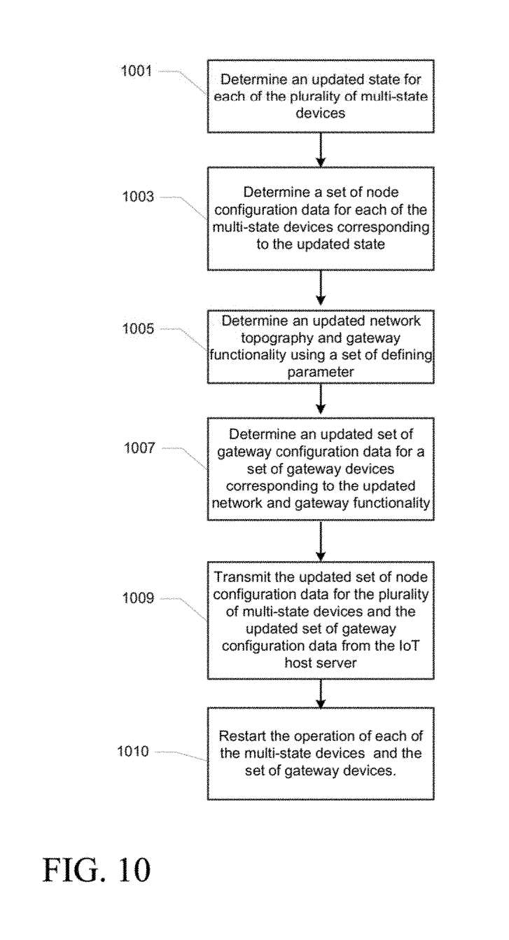

FIG. 10 illustrates a flowchart of possible operations that may he performed by an IoT network according to an embodiment of the present invention. The sequence of operations of FIG. 10 correspond to the operation of network of multi-state edge devices of FIG. 1-8 above when the edge devices are operating in an updated state upon the receipt of a detected event by the IoT host server. The process begins in block 1001 in which the updated operating state is determined for each of the multi-state edge devices needed to support the detected event. As discussed above, the detected event may correspond to a scheduled event or an external event received by the IoT host server. In block 1003, a set of configuration data is generated for each of the multi-state edge devices that will place the devices into the updated operating state for the detected event.

Block 1005 determines an updated network topography and edge gateway operating parameters to support network communications when the edge devices are operating in the updated state. Depending upon the needs of the network in the updated state, the network configuration, topography, and allocated bandwidth may change as needed. Block 1007 then generates a set of configuration data for the edge device network modules and the edge gateways to generate the updated network topography and edge gateway operating parameters.

All of the above updated configuration data is transmitted by the IoT host server to the edge devices and edge gateways in block 1009. Once all of the data is in place in the devices, block 1010 restarts the operation of the devices that causes the network of IoT devices and its network to operate in its new operating state. The network and edge devices will remain in the updated state until the next detected event in which the IoT host server will again reconfigure all of the devices; either to a second updated state or back to the default operating state depending upon the next detected event.

While the above embodiments of the present invention describe the interaction of System and Method for Providing Secure and Redundant Communications and Processing for a Collection of Internet of Things (IoT) Devices, one skilled in the art will recognize that the use of software within programmable servers may be replaced with firmware or programmable logic within the network devices. It is to be understood that other embodiments may be utilized and operational changes may be made without departing from the scope of the present invention.

One of ordinary skill in the art will appreciate that any process or method descriptions herein may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions. It will be apparent to those skilled in the art that many changes and substitutions can be made to the embodiments described herein without departing from the spirit and scope of the disclosure as defined by the appended claims and their hill scope of equivalents.

What is claimed is:

1. A method for configuring a plurality of multi-state network devices within a dynamically configurable multi-path communications network within a IoT host server, the method comprising:
determining a default state for each of the plurality of multi-state devices within the dynamically configurable multi-path communications network;
determining a set of node configuration data for each of the plurality of multi-state devices within the dynamically configurable multi-path communications network corresponding to the default state;
determining a recommended network topography and gateway functionality using a set of defining parameters;
determining a set of gateway configuration data for a set of gateway devices corresponding to the recommended network and gateway functionality;
transmitting the set of node configuration data for each of the plurality of multi-state devices within the dynamically configurable multi-path communications network and the set of gateway configuration data for a set of gateway devices corresponding to the recommended network and gateway functionality from the IoT host server;
starting the operation of each of the plurality of multi-state devices within the dynamically configurable multi-path communications network and the set of gateway devices.

2. The method according to claim 1, wherein the method further comprises:
responding to a detected event by the IoT host server by:
determining a default state for each of the plurality of multi-state devices within the dynamically configurable multi-path communications network;
determining an updated set of node configuration data for each of the plurality of multi-state devices within the dynamically configurable multi-path communications network corresponding to a new device state needed by the detected event;
determining recommending an updated network topography and updated gateway functionality using a set of defining parameters as needed by the detected event;
determining a set of updated gateway configuration data for the set of gateway devices corresponding to the updated recommended network and gateway functionality;
transmitting the set of updated node configuration data for each of the plurality of multi-state devices within the dynamically configurable multi-path communications network and the set of updated gateway configuration data for a set of gateway devices corresponding to the recommended network and gateway functionality from the IoT host server;
restarting the operation of each of the plurality of multi-state devices within the dynamically configurable multi-path communications network and the set of gateway devices.

3. The method according to claim 2, wherein the detected event corresponds to a scheduled event.

4. The method according to claim 2, wherein the detected event corresponds to an external event.

5. A computer program product for configuring a set of network devices, comprising:
a non-transitory computer-readable medium comprising a set of instructions that when executed by a programmable computing device causes the computing device to implement a method for configuring a set of network devices, the method comprising:
determining a default state for each of the plurality of multi-state edge devices within the dynamically configurable multi-path communications network;
determining a set of node configuration data for each of the plurality of multi-state edge devices within the dynamically configurable multi-path communications network corresponding to the default state;
determining a recommended network topography and gateway functionality using a set of defining parameters;
determining a set of gateway configuration data for a set of gateway devices corresponding to the recommended network and gateway functionality;
transmitting the set of node configuration data for each of the plurality of multi-state edge devices within the dynamically configurable multi-path communications network and the set of gateway configuration data for a set of gateway devices corresponding to the recommended network and gateway functionality from the IoT host server;
starting the operation of each of the plurality of multi-state edge devices within the dynamically configurable multi-path communications network and the set of gateway devices.

6. The computer program product according to claim 5, wherein the method further comprises:
responding to a detected event by the IoT host server by:
determining a default state for each of the plurality of multi-state devices within the dynamically configurable multi-path communications network;
determining an updated set of node configuration data for each of the plurality of multi-state edge devices within the dynamically configurable multi-path communications network corresponding to a new device state needed by the detected event;
determining recommending an updated network topography and updated gateway functionality using a set of defining parameters as needed by the detected event;
determining a set of updated gateway configuration data for the set of gateway devices corresponding to the updated recommended network and gateway functionality;
transmitting the set of updated node configuration data for each of the plurality of multi-state edge devices within the dynamically configurable multi-path communications network and the set of updated gateway configuration data for a set of gateway devices corresponding to the recommended network and gateway functionality from the IoT host server;
restarting the operation of each of the plurality of multi-state devices within the dynamically configurable multi-path communications network and the set of gateway devices.

7. The method according to claim 6, wherein the detected event corresponds to a scheduled event.

8. The method according to claim 6, wherein the detected event corresponds to an external event.

9. A distributed computing system, having an IoT Host server, one or more Gateway devices, and a plurality of IoT Edge devices, for configuring a set of network devices, the IoT Host computer comprising:
an IoT Device Discovery module for discovering all devices within an IoT network, the IoT network comprising an IoT Host computer, one or more gateway devices, and a plurality of IoT Edge devices;
a Gateway Config module for recommending a network topography and node functionality using a set of defining parameters;
an operator interface module for accepting modifications to one or more of the defining parameters within the set of defining parameters;
a Network Present module for updating the network topography and node functionality using the modifications to the defining parameters; and
an edge device config module for determining an operating state for each of the plurality of multi-state edge devices within the dynamically configurable multi-path communications network;
wherein the operating state for each of the plurality of multi-state edge devices includes a default state and an updated state for each detected event; and
each detected event includes a scheduled event and an external event.

10. The distributed computing system according to claim 9, wherein the plurality of IoT edge devices comprises:
a network interface module;
a sensor module; and
a multi-state control module.
